(19) United States
(12) Patent Application Publication
(10) Pub. No.: US 2021/0035240 A1
(43) Pub. Date: Feb. 4, 2021

(54) TRUSTABLE INFORMATION CHAIN FOR FISHING, SEAFOOD, OR OTHER INDUSTRIES

(71) Applicant: Robert Scott Echols, Cathlamet, WA (US)

(72) Inventor: Robert Scott Echols, Cathlamet, WA (US)

(21) Appl. No.: 16/936,852

(22) Filed: Jul. 23, 2020

Related U.S. Application Data
(60) Provisional application No. 62/881,722, filed on Aug. 1, 2019.

(51) Int. Cl. G06Q 50/02; G06Q 50/28; G06Q 30/00; G06Q 50/26; H04L 29/06

(52) U.S. Cl. CPC G06Q 50/02; G06Q 50/28; G06Q 30/0185; H04L 2209/38; H04L 63/0442; G06Q 2220/00; G06Q 50/26

(57) ABSTRACT

A trustable information chain management system for facilitating supply chain and/or marketplace transactions involved with the fishing, seafood, or other industries, and associated methods, is disclosed herein. In some embodiments, a computer-implemented method for creating an information chain for a transaction related to a seafood product is provided. In some embodiments the method can include: receiving, by a first entity, a first information chain packet, wherein the first information chain packet includes first data of a first transaction related to the seafood product; decrypting at least a portion of the first information chain packet; creating a packet base including (1) second data of a second, subsequent transaction related to the seafood product and (2) a reference to the first information chain packet; generating a second information chain packet by encrypting at least a portion of the packet base; and transmitting the second information chain packet to a second entity.

### CROSS-REFERENCE TO RELATED APPLICATION(S)

The present application claims the benefit of U.S. Provisional Patent Application No. 62/881,722, filed Aug. 1, 2019, which is incorporated by reference herein in its entirety.

### BACKGROUND

Commercial fishing activity is aimed at the delivery of fish and other seafood products for human consumption or as input factors in other industrial processes. Related aspects can involve any industry, institution, or activity concerned with taking, culturing, processing, preserving, storing, transporting, marketing, buying, and/or selling fish or fish products, among other relevant activities. For example, fish processing is the processing of fish delivered by commercial fisheries, fish farms, and/or other sources. Primary processing can involve the heading and gutting of seafood, extracting byproducts such as roe, freezing for inventory storage, and/or shipping in fresh or frozen form for onward distribution. Secondary processing can involve filleting, boning, skinning, and/or repackaging seafood for storage and/or shipping that connects to the wholesale, food services, retail, and catering trades. Seafood marketing can involve the trade in and sale of seafood and byproducts. They can be dedicated to wholesale trade between seafood producers and seafood merchants, or to the sale of seafood to individual consumers, or to both. These industries have provoked various disputes as wild fish capture rose to a peak about the turn of the century, e.g., disputes about maximum sustainable yields and allowable catch amounts, use of commercial fishing gear that does not differentiate between target species, fishing across international boundaries. Therefore, there is a need for a trustable information system to securely account, monitor, guide, trace, evidence, validate, and/or otherwise facilitate the various transactions involved with commercial fisheries, e.g., for consumers or other entities who demand a trusted supply chain for seafood products.

### BRIEF DESCRIPTION OF THE DRAWINGS

FIG. 1 illustrates an example operating environment of the presently disclosed technology.

FIG. 2 illustrates an example information chain packet in accordance with some embodiments of the presently disclosed technology.

FIG. 3 is a flowchart illustrating an example process for a current packet handler to participate in chain building, in accordance with some embodiments of the presently disclosed technology.

FIG. 4 is a flowchart illustrating an example process for a chain originator to create an origin packet for information chain(s) in accordance with some embodiments of the presently disclosed technology.

FIG. 5 shows an example of information chain building based on the packet format of FIG. 2 and the processes of FIGS. 3 and 4.

FIG. 6 illustrates an example information chain packet in accordance with some embodiments of the presently disclosed technology.

FIG. 7 shows an example of information chain building based on the packet format of FIG. 6 and the processes of FIGS. 3 and 4.

FIG. 8 is a block diagram illustrating an example of the architecture for a computer system or other computing device that can be utilized to implement various portions of the presently disclosed technology.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

Various embodiments are disclosed of a trustable information chain management system that enables information packet generation, chain building, and/or information extraction in a trustable and traceable manner to facilitate various supply chain and/or marketplace transactions involved with the fishing, seafood, or other industries. Illustratively, an information chain can correspond to a route passing through various information packet handlers (e.g., government entities, fishing vessels, seafood processors, transporters, wholesalers, retailers, consumers, or the like). As will be described in more detail below, the information chain can include splits and mergers, and/or can run at least partially in parallel with other information chain(s) to accommodate a variety of real-world frameworks of transactions.

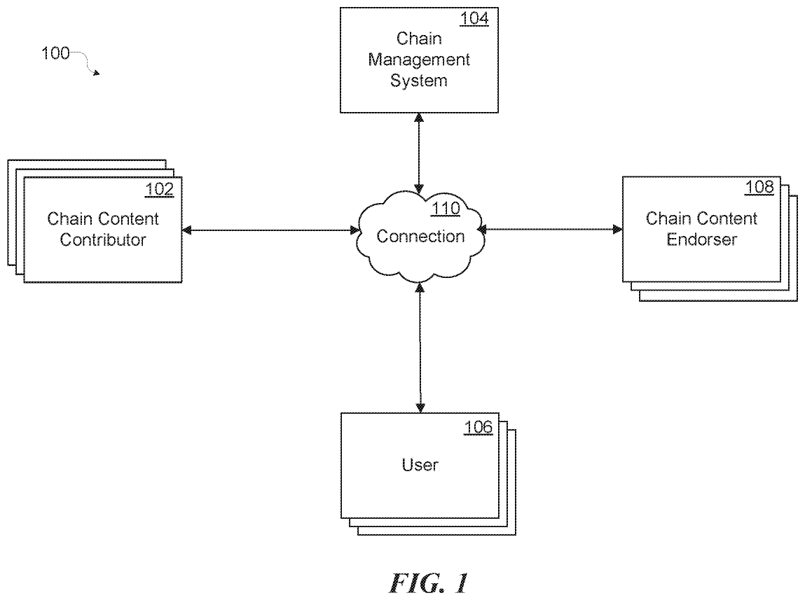

Turning now to the figures, FIG. 1 illustrates an example operating environment 100 of the presently disclosed technology. The operating environment 100 can include a chain management system 104, one or more chain content contributors 102, one or more chain content endorsers 108, and one or more users 106 that are communicatively connected with one another via connection 110. Illustratively, a content contributor 102 can contribute content (e.g., transaction details such as, e.g., bonded buyer fish ticket indexing, supply chain-of-origin, etc.) to a packet when a chain is being built, an endorser 108 can simply provide endorsement (e.g., via a layer of encryption) without contributing substantive content, and a user 106 can be a passive consumer of information extracted from the chain. Illustratively, individual components of operating environment 100 can be implemented on one or more computing devices. Illustratively, the connection 110 can include various types of wired and/or wireless communications (e.g., local area network, cellular network, WiFi connections, Bluetooth connections, or the like).

Each chain content contributor 102 and endorser 108 can be associated with one or more corresponding private key/public key pairs for encrypting/decrypting data that constitutes a packet. Illustratively, a contributor 102 or endorser 108 can generate its unique private/public key pair(s) locally in accordance with asymmetric cryptography techniques such as Diffie-Hellman key exchange protocol, Digital Signature Standard (DSS), ElGamal, various elliptic curve techniques, various password-authenticated key agreement techniques, Paillier cryptosystem, RSA encryption algorithm (PKCS #1), Cramer-Shoup cryptosystem, and/or YAK authenticated key agreement protocol. The contributor 102 or endorser 108 keeps the generated private key(s), while the corresponding public key(s) can be communicated to the general public, a group of participants of the operating environment 100, or one or more designated entities, in accordance with various embodiments.

The chain management system 104 can provide storage for chain packets, facilitate packet access, and enable interactions among participants of the operating environment 100, in accordance with various embodiments. In some embodiments, chain packet(s) or certain content referred to by chain packet(s) can be stored in an immutable manner in one or more blockchains.

In some embodiments, the contributor 102, endorser 108, and user 106 can be different participants in a supply chain for a seafood product, or can be computing devices or systems that are operated by or otherwise associated with different participants in the supply chain. Participants in the supply chain can include any of the following: a permitting organization, a government entity, a fishing vessel, a processor (e.g., a primary processor or secondary processor), a transporter, a distributor, a wholesaler, a retailer, or a consumer (e.g., a restaurant or an individual consumer).

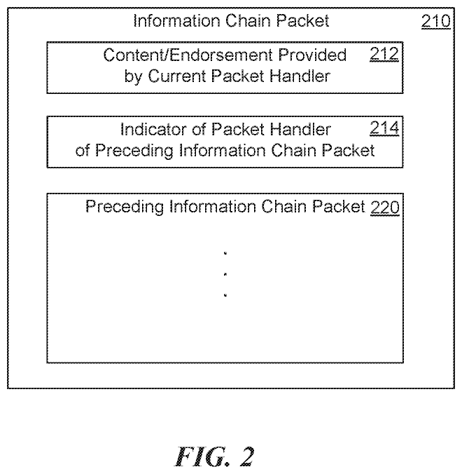

FIG. 2 illustrates an example information chain packet 210 in accordance with some embodiments of the presently disclosed technology. The information chain packet 210 can include (a) content and/or endorsement 212 provided by a current packet handler (e.g., a chain content contributor 102 or a chain content endorser 108) and (b) an indicator 214 of a packet handler that handled a packet 220 immediately preceding the current packet in the information chain. The current information chain packet 210 also includes or otherwise indicates (e.g., via a pointer or reference to a location of data storage) the preceding packet 220 itself. If the information chain packet 210 is an origin packet to start a chain, the packet 210 does not include the indicator 214 of the preceding packet 220 because there is none.

In some embodiments, the preceding packet 220 includes first data of a first transaction related to a seafood product, and the information chain packet 210 includes second data of a second, subsequent transaction related to the seafood product. The first and second transactions can be different transactions (e.g., commercial fishery transactions) in a supply chain for the seafood product. For example, each of the different transactions can include one or more of the following: issuance of a catch ticket for, e.g., a fish or shellfish species used to produce the seafood product, harvesting of a catch of the fish or shellfish species, transportation of the catch to a processor, processing of the catch to produce the seafood product, sale of the seafood product to a wholesaler or retailer, or sale of the seafood product to a consumer.

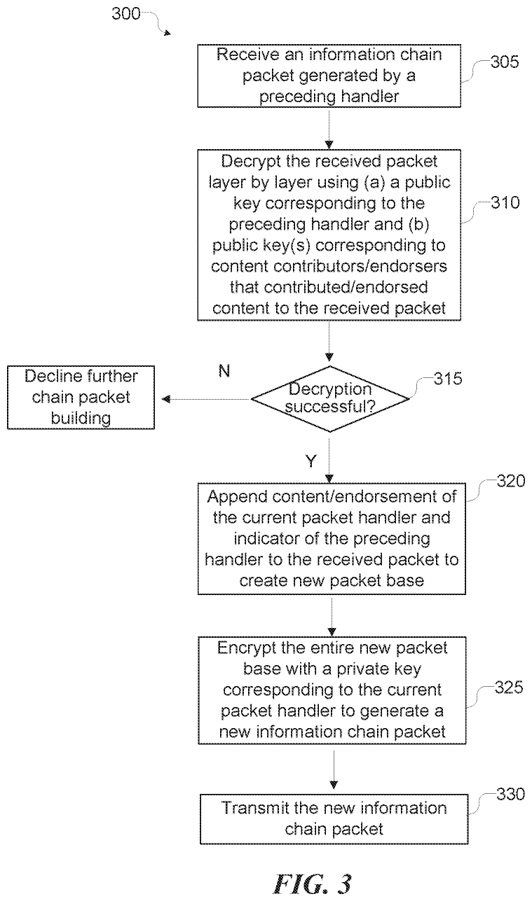

FIG. 3 is a flowchart illustrating an example process 300 for a current packet handler (e.g., a chain content contributor or endorser) to participate in chain building, in accordance with some embodiments of the presently disclosed technology.

At block 305, the current packet handler receives an information chain packet generated by a preceding handler. In various embodiments, the current packet handler can access the chain management system to retrieve the preceding packet, receive the preceding packet directly sent by the preceding handler, or receive the preceding packet forwarded by another entity.

At block 310, the current packet handler decrypts at least a portion of the received packet or the entire packet layer by layer. Illustratively, the currently packet handler uses a public key corresponding to the preceding handler to decrypt the received packet, and accesses the content (or verifies the endorsement) that the preceding handler provided to the received packet. In many cases, indicator(s) of further preceding packet handler(s) that handled one or more deeper layer packets are included in the received packet. In these cases, the current packet handler can (1) identify the further preceding packet handler(s) and (2) for each identified further preceding packet handler, use a public key corresponding to the further preceding packet handler to decrypt the deeper layer packet. The current packet handler can perform these actions to drill into deeper and deeper layers of the received packet until the origin packet is decrypted.

At block 315, the current packet handler determines whether the decryption(s) performed at block 310 is successful. If not, that can mean one or more packets in the current chain are compromised, and the current packet handler can decline to perform further chain building and/or take remedial actions. If the decryption(s) is successful, the process 300 proceeds to block 320.

At block 320, the current packet handler can append, insert, or otherwise add content/endorsement of the current packet handler and an indicator of the preceding handler to the received packet (or a copy thereof) to create a new packet base. In some embodiments, the current packet handler can endorse the packet simply based on a layer of encryption (e.g., as implemented at block 325 below), and no endorsement data needs to be added. Illustratively, the content/endorsement and indicator can be added to the beginning or end of the received packet, or otherwise attached to the received packet. In some embodiments, the current packet handler can add other received packets to the new packet base.

At block 325, the current packet handler encrypts at least a portion of the new packet base or the entire new packet base with a private key corresponding to the current packet handler, thereby generating a new packet for the information chain. At block 330, the current packet handler transmits the new packet. In various embodiments, the new packet can be transmitted to the chain management system for storage, transmitted directly or indirectly to next packet handler(s) for continued chain building, or transmitted to user(s) that can decrypt, extract, and/or verify information conveyed by the chain.

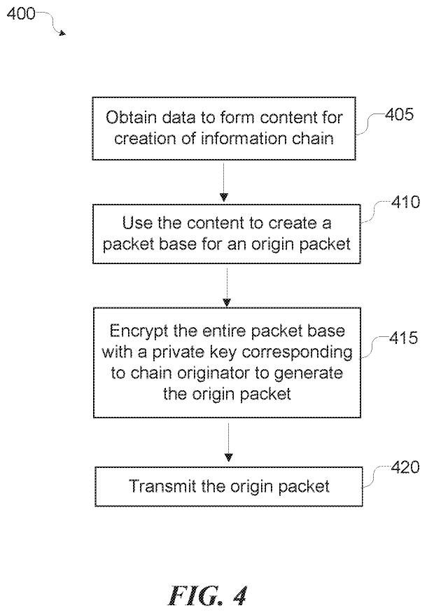

FIG. 4 is a flowchart illustrating an example process 400 for a chain originator (e.g., a chain content contributor) to create an origin packet for information chain(s).

At block 405, the chain originator obtains data (e.g., transaction details such as source, quantity, type, and/or other specifications) to form content for creation of one or more information chains. At block 410, the chain originator uses the content to create a packet base for the origin packet. Illustratively, the content can be filtered, converted, standardized, or otherwise processed to form the packet base.

At block 415, the chain originator encrypts the entire packet base with a private key corresponding to the chain originator to generate the origin packet. At block 420, the chain originator transmits the origin packet. In various embodiments, the origin packet can be transmitted to the chain management system for storage or transmitted directly or indirectly to next packet handler(s) for continued chain building.

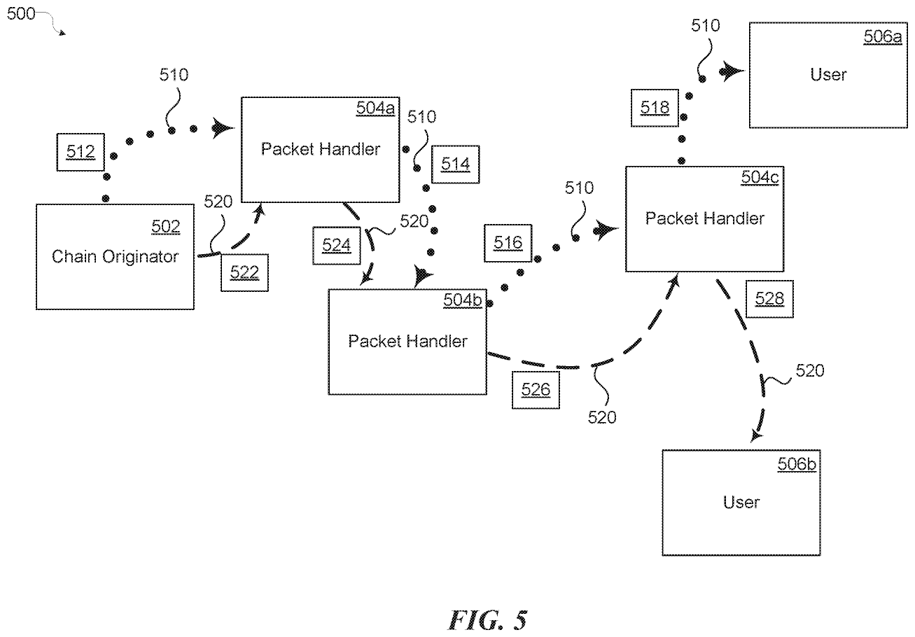

FIG. 5 shows an example of information chain building 500 based on the packet format of FIG. 2 and the processes of FIGS. 3 and 4. Illustratively, a chain originator 502 can generate one or more origin packets 512, 522 to start one or more chains 510, 520. Multiple chains can run through a same sequence of packet handlers 504a-c concurrently or non-concurrently. Each packet handler 504a-c can generate and add one or more packets 514-518, and 524-528 to the respective chains 510, 520. These chains 510, 520 can be generally referred to as parallel chains, which can ultimately reach different users 506a-b who may decrypt and/or verify information included in the respective chains 510, 520. In some embodiments, the parallel chains can include some chain(s) carrying a larger or complete set of information, some chain(s) carrying a smaller or subset of information, some chain(s) carrying different types/categories of information, which can ultimately be consumed by different types of users 506a-b.

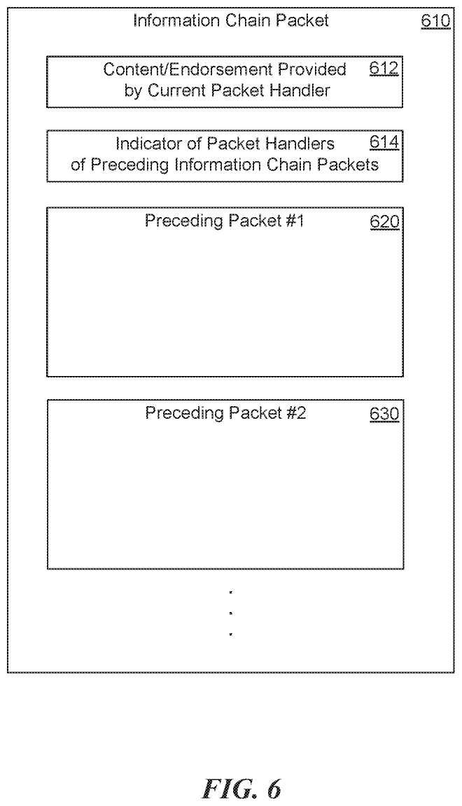

FIG. 6 illustrates an example information chain packet 610 in accordance with some embodiments of the presently disclosed technology. The information chain packet 610 can include (a) content and/or endorsement 612 provided by a current packet handler (e.g., a chain content contributor 102 or a chain content endorser 108) and (b) an indicator 614 of one or more packet handlers that handled packet(s) 620, 630, or the like that precede the current packet in the information chain. The current information chain packet 610 also includes or otherwise indicates (e.g., via pointer(s) or reference(s)) the preceding packet(s) 620, 630 themselves. If the information chain packet 610 is an origin packet to start a chain, the packet 610 does not include the indicator 614 or the preceding packet(s) 620, 630, or the like.

In some embodiments, the preceding packet 620 includes first data of a first transaction related to a seafood product, and the information chain packet 610 includes second data of a second, subsequent transaction related to the seafood product. The preceding packet 630 can include third data of a third transaction related to the seafood product that occurred before the first transaction, and so on. Each of these transactions can include one or more of the following: issuance of a catch ticket for, e.g., a fish or shellfish species used to produce the seafood product, harvesting of a catch of the raw fish or shellfish species, transportation of the catch to a processor, processing of the catch to produce the seafood product, sale of the seafood product to a wholesaler or retailer, or sale of the seafood product to a consumer. In this manner, the information chain packet 610 can provide a trustable record of any number of sequential transactions in the supply chain for the seafood product.

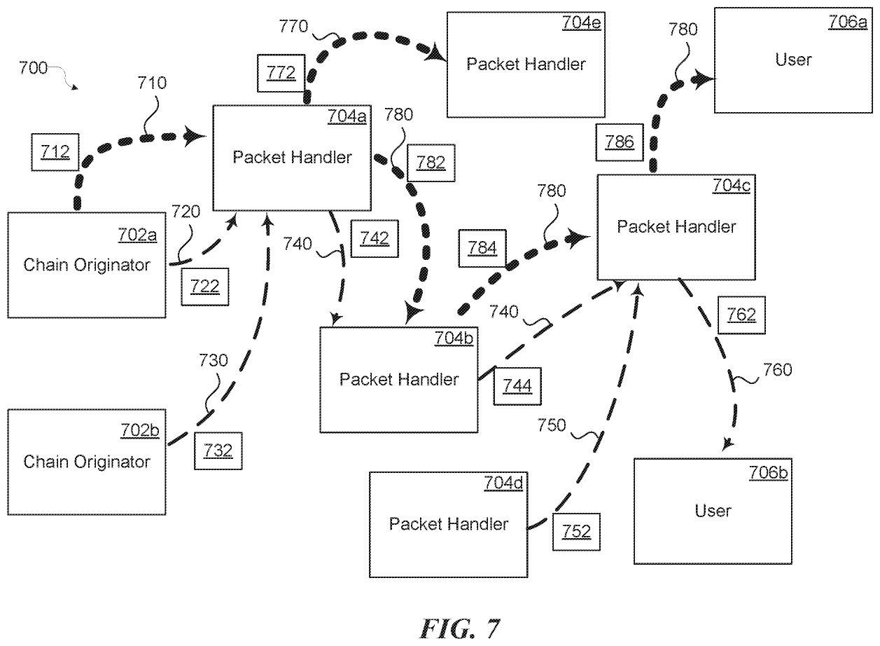

FIG. 7 shows an example of information chain building 700 based on the packet format of FIG. 6 and the processes of FIGS. 3 and 4. Illustratively, one or more chains 710, 720, 730 can be started from one or more origin packets 712, 722, 732, respectively, generated by one or more chain originators 702a-b, and can run through one or more packet handlers 704a-e. A packet handler can merge two or more chains by processing multiple received packets to create a new packet for a merged chain. For example, in the illustrated embodiment, packet handler 704a receives and processes packets 722, 732 from chains 710, 720, respectively, to create a new packet 742 for a merged chain 740. As another example, packet handler 704c can receive and process packets 744, 752 from chains 740, 750, respectively, to create a new packet 762 for a merged chain 760. A packet handler can split a chain by transmitting a newly generated packet to multiple packet handler(s) for further chain building and/or users 706a-b for information decryption/verification. For example, packet handler 704a can split chain 710 into new chains 770, 780 by creating new packets 772, 782, respectively. The subsequent packet handlers 704b-704c can continue propagating the chain 780 by adding new packets 784, 786.

Embodiments of the presently disclosed technology can be implemented in various use cases. For example, as discussed above, the information chain building processes described herein can be used to create an information chain for a plurality of different transactions in a supply chain for a seafood product. In such embodiments, an information chain can originate with a catch ticket from a permitting organization (e.g., a government entity or regulating body) for a fish or shellfish species used to produce the seafood product. This ticket can indicate the projected catch and/or assessment (e.g., maximum sustainable yield) for a particular species within a particular region. This ticket can be included in the content of an origin packet for the information chain. Accordingly, the origin packet can contain data indicating various aspects of the ticket such as information regarding species, gear types, geographic region of permit, quota, timeframe of the ticket, total allowable catch, vessel size, and/or any other relevant information from the permitting organization.

This origin packet is encrypted using a private key of the permitting organization and can be transmitted over a communication network to a recipient fishing vessel or other entity that harvests the seafood species. The fishing vessel decrypts the origin packet containing the catch ticket using a corresponding public key of the permitting organization. The vessel creates a second packet that contains information such as the vessel identification, actual catch landing numbers or other landing metrics, average size of the target species, catch area, GPS coordinates of the catch, bycatch, overboard raw fish with no value discards, and/or other information that is included a harvest certification. In accordance with the packet format illustrated by FIG. 2 and/or FIG. 6, this second packet is linked and associated with the earlier received origin packet by encapsulating the origin packet within the second packet, creating a traceable cascade of information. This second packet is encrypted with a private key of the fishing vessel before being transmitted to the next participant in the supply chain, such as a primary buyer or processor of fish, shellfish or other species used to produce the seafood product.

The primary buyer/processor can decrypt the cascade of information within the second packet using a corresponding public key of the fishing vessel and the corresponding public key of the permitting organization. The primary processor can generate a third packet with relevant raw supply information, such as the real weight of the catch taken from a vessel, the weight of processed finished product(s), and/or licensing information required in a processing certification. Using this information in combination with the information contained in the preceding packets in the chain (e.g., the second packet and the origin packet residing therein) would allow the primary processor to perform various calculations such as supply chain efficiency, recovery at each step of the chain accounting for shrinkage or discards, job cost analysis, or pricing invoice analysis. Again, this third packet is linked and associated with the earlier received second packet by encapsulating the second packet within the third packet. Because the second packet itself encapsulates the origin packet, a traceable cascade of information continues seamlessly. This third packet is encrypted with a private key of the primary processor before being transmitted to the next participant in the supply chain or marketplace.

As the traceable cascade of information is built up in a chain that passes through various packet handlers, this chain can indicate each phase of the supply chain, e.g., from the projected catch, landings process, transportation, entry into the marketplace, to end consumer point-of-sale register. The encryption of information before packet transmittance from one entity to the next, using a private key specific to the information contributor, creates temper-resistant and traceable records of the transactions. In some embodiments, the information chain ends when the seafood product reaches its final destination (e.g., final point of sale) and/or once the final transaction in the supply chain is completed. For example, the information chain can terminate once the seafood product is sold to an end consumer (e.g., a restaurant, an individual consumer, etc.). The consumer may access the information in the supply chain to trace the product back to its origin before making purchase decisions.

In another example, an information chain can include splits as it is being built. Illustratively, after a fishing vessel owner or seller has delivered the landed catch and transmitted the associated packet to a processor (e.g., primary and/or secondary processor), the processor can split the catch into separate raw-whole/round fish groups each serving as a basis for a separate new packet. A primary processor may also separate out various products such as headed and gutted, skin-on filets, fresh packs, frozen packs, or the like. Each user or purchaser of the separate products can have or define a new packet associated with it (e.g., including information such as finished weight, fresh or frozen packing specifications, delivery date schedule) while remaining linked to (e.g., encapsulating) the preceding packet that represents the origin of the landed external catch. The separate product packets can each be encrypted using a private key of the processor and transmitted to different supply chain participants (e.g., another processor to further process, a distributor, a transporter, an exporter, an importer, a cold storage facility, or the like) in the next stage of the supply chain. Conversely, an information chain can include merging or consolidating multiple packets as it is being built. For example, fish products sourced from several different suppliers (each associated with a distinct packet) can be combined for transportation or for producing a single type of seafood product in the supply chain. In this case, a packet handler receiving the different information packets from multiple senders can encapsulate them in a single new packet with newly contributed content. The single new packet is encrypted with a private key of the packet handler before being transmitted to the next recipient.

In yet another example, there may be multiple chains operating in parallel. Each chain may have different information contained in each of the packets that are associated with the same event within the supply chain. For example, one chain may contain packets with detailed information such as geographic catch area location, estimated average size of catch, actual landing numbers. This information may be important to downstream producers, distributors, wholesalers, food service providers, retailers, etc. (e.g., to forecast finished product weights, delivery dates, purchase order scheduling), but may not be useful to other entities. A second chain that corresponds to the same supply chain may only contain basic information such as species name, name of fishing vessel(s), fishing region, and/or sustainable yield management approaches, which may interest an average end-consumer (e.g., a consumer wanting trusted supply information in order to make sustainable purchase decisions). Separate parallel chains work to permit various levels of access to the underlying information. This serves as a mechanism to maintain separate, privileged information while allow easy access to public information. Additional parallel chains can be used to carry only the information necessary for oversight and regulatory purposes without containing the data that a supply chain participant may deem confidential (e.g., vessel size, vessel owner information, etc. may not be used in the public domain without a signed release). These parallel chains may be created based on encryption/decryption using different sets of private/public key pairs generated by each individual packet handler.

While processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

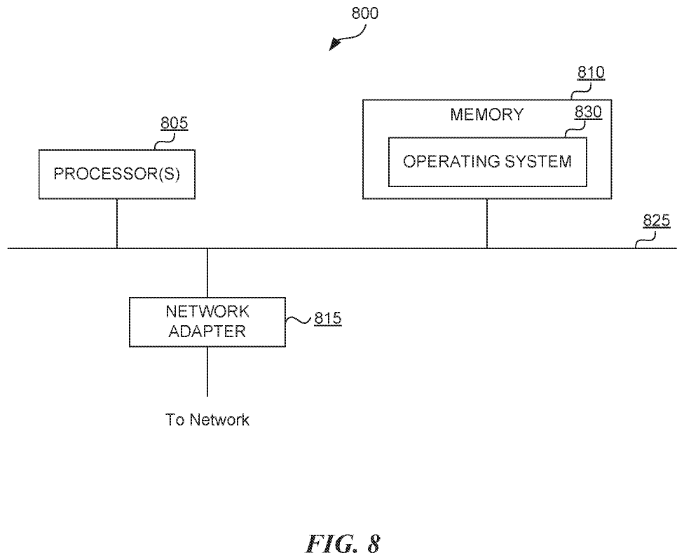

FIG. 8 is a block diagram illustrating an example of the architecture for a computer system 800 or other computing device that can be utilized to implement various portions of the presently disclosed technology. In FIG. 8, the computer system 800 includes one or more processors 805 and memory 810 connected via an interconnect 825. The interconnect 825 may represent any one or more separate physical buses, point to point connections, or both, connected by appropriate bridges, adapters, or controllers. The interconnect 825, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire.” The processor(s) 805 may include central processing units (CPUs) to control the overall operation of, for example, the host computer. In certain embodiments, the processor(s) 805 accomplish this by executing software or firmware stored in memory 810. The processor(s) 805 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices. The memory 810 can be or include the main memory of the computer system. The memory 810 represents any suitable form of random access memory (RAM), read-only memory (ROM), flash memory, or the like, or a combination of such devices. In use, the memory 810 may contain, among other things, a set of machine instructions which, when executed by processor(s) 805, causes the processor(s) 805 to perform operations to implement embodiments of the presently disclosed technology. In some embodiments, the memory 810 can contain an operating system (OS) 830 that manages computer hardware and software resources and provides common services for computer programs. Also connected to the processor(s) 805 through the interconnect 825 is a network adapter 815. The network adapter 815 provides the computer system 800 with the ability to communicate with remote devices, such as the storage clients, and/or other storage servers, and may be, for example, an Ethernet adapter or Fiber Channel adapter.

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “computer-readable storage medium” or a “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

Although certain embodiments of the present technology are described herein in the context of fisheries and seafood, it will be appreciated that the systems, devices, and methods described herein can be implemented in the context of industries involving other types of natural resources, such as forestry, hunting, mining, oil and gas drilling, etc.

Some embodiments of the disclosure have other aspects, elements, features, and steps in addition to or in place of what is described above. These potential additions and replacements are described throughout the rest of the specification. Reference in this specification to “various embodiments,” “certain embodiments,” or “some embodiments” means that a particular feature, structure, or characteristic described in connection with the embodiment is included in at least one embodiment of the disclosure. These embodiments, even alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but no other embodiments.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A computer-implemented method for creating an information chain for a transaction related to a seafood product, the method comprising:
receiving, by a first entity, a first information chain packet, wherein the first information chain packet includes first data of a first transaction related to the seafood product;
decrypting at least a portion of the first information chain packet;
creating a packet base including—
(1) second data of a second, subsequent transaction related to the seafood product, and
(2) a reference to the first information chain packet;
generating a second information chain packet by encrypting at least a portion of the packet base; and
transmitting, by the first entity, the second information chain packet to a second entity.

2. The computer-implemented method of claim 1, wherein the first and second transactions are different transactions in a supply chain for the seafood product.

3. The computer-implemented method of claim 2, wherein each of the different transactions includes one or more of the following: issuance of a catch ticket for a fish or shellfish species used to produce the seafood product, harvesting of a catch of the fish or shellfish species, transportation of the catch to a processor, processing of the catch to produce the seafood product, sale of the seafood product to a wholesaler or retailer, or sale of the seafood product to a consumer.

4. The computer-implemented method of claim 2, wherein the first information chain packet further includes a reference to a third information chain packet, the third information chain packet including third data of a third transaction related to the seafood product, wherein the third transaction is a transaction in the supply chain for the seafood product that occurred before the first transaction.

5. The computer-implemented method of claim 1, wherein the first information chain packet is generated by a packet handler associated with one or more of the following: a permitting organization, a government entity, a fishing vessel, a processor, a transporter, a distributor, a wholesaler, a retailer, or a consumer.

6. The computer-implemented method of claim 1, wherein:
the first transaction includes issuance of a catch ticket for a fish or shellfish species used to produce the seafood product; and
the first data includes one or more of the following: the fish or shellfish species on the catch ticket, permitted gear type for harvesting the fish or shellfish species, permitted geographic region for harvesting the fish or shellfish species, or permitted timeframe for harvesting the fish or shellfish species.

7. The computer-implemented method of claim 6, wherein:
the second, subsequent transaction includes harvesting of a catch of the fish species by a recipient of the catch ticket; and
the second data includes one or more of the following: identification of a vessel that harvested the catch, landing numbers for the catch, size of an area where the catch was harvested, coordinates of the catch, or a harvesting certification for the catch.

8. The computer-implemented method of claim 1, wherein:
the first transaction involves harvesting a catch of fish or shellfish used to produce the seafood product; and
the first data includes one or more of the following: identification of a vessel that harvested the catch, landing numbers for the catch, size of an area where the catch was harvested, coordinates of the catch, or a harvesting certification for the catch.

9. The computer-implemented method of claim 8, wherein:
the second, subsequent transaction includes processing of the catch to produce the seafood product; and
the second data includes one or more of the following: weight of the catch, weight of the seafood product produced from the catch, or a processing certification.

10. The computer-implemented method of claim 1, wherein the second entity is a packet handler or an information chain management system.

11. A computer-readable medium containing nonvolatile instructions that, when executed by a processor, cause a system for creating an information chain related to a seafood product to perform a method comprising:
receiving, by a first entity, a first information chain packet, wherein the first information chain packet includes first data of a first transaction related to the seafood product;
decrypting at least a portion of the first information chain packet;
creating a packet base including (1) second data of a second, subsequent transaction related to the seafood product and (2) a reference to the first information chain packet;
generating a second information chain packet by encrypting at least a portion of the packet base; and
transmitting the second information chain packet to a second entity.

12. The computer-readable medium of claim 11, wherein the first and second transactions are different transactions in a supply chain for the seafood product.

13. The computer-readable medium of claim 12, wherein each of the different transactions includes one or more of the following: issuance of a catch ticket for a fish or shellfish species used to produce the seafood product, harvesting of a catch of the fish or shellfish species, transportation of the catch to a processor, processing of the catch to produce the seafood product, sale of the seafood product to a wholesaler or retailer, or sale of the seafood product to a consumer.

14. The computer-readable medium of claim 12, wherein the first information chain packet further includes a reference to a third information chain packet, the third information chain packet including third data of a third transaction related to the seafood product, wherein the third transaction is a transaction in the supply chain that occurred before the first transaction.

15. The computer-readable medium of claim 11, wherein the first information chain packet is generated by a packet handler associated with one or more of the following: a permitting organization, a government entity, a fishing vessel, a processor, a transporter, a distributor, a wholesaler, a retailer, or a consumer.

16. The computer-readable medium of claim 11, wherein:
the first transaction includes issuance of a catch ticket for a fish or shellfish species used to produce the seafood product; and
the first data includes one or more of the following: the fish or shellfish species on the catch ticket, permitted gear type for harvesting the fish or shellfish species, permitted geographic region for harvesting the fish or shellfish species, or permitted timeframe for harvesting the fish or shellfish species.

17. The computer-readable medium of claim 16, wherein:
the second, subsequent transaction includes harvesting of a catch of the fish or shellfish species by a recipient of the catch ticket; and
the second data includes one or more of the following: identification of a vessel that harvested the catch, landing numbers for the catch, size of an area where the catch was harvested, coordinates of the catch, or a harvesting certification for the catch.

18. The computer-readable medium of claim 11, wherein:
the first transaction involves harvesting a catch of fish or shellfish used to produce the seafood product; and
the first data includes one or more of the following: identification of a vessel that harvested the catch, landing numbers for the catch, size of an area where the catch was harvested, coordinates of the catch, or a harvesting certification for the catch.

19. The computer-readable medium of claim 18, wherein:
the second, subsequent transaction includes processing of the catch to produce the seafood product; and
the second data includes one or more of the following: weight of the catch, weight of the seafood product produced from the catch, or a processing certification.

20. The computer-readable medium of claim 11, wherein the second entity is a packet handler or an information chain management system.
